(19) United States
(12) Patent Application Publication
(10) Pub. No.: US 2005/0231717 A1
(43) Pub. Date: Oct. 20, 2005

(54) Fluorescence inspection spectrometer

(75) Inventors: Kuang-Wu Hsu, Hsinchu (TW); Chi-Lone Chang, Hsinchu (TW); Yuan-Chin Lee, Hsinchu (TW); Tzuan-Ren Jeng, Hsinchu (TW); Jau-Jiu Ju, Hsinchu (TW); Hae-Ruoh Huang, Hsinchu (TW)

Correspondence Address: Welsh & Katz, Ltd.;Eric D. Cohen, 22nd Floor, 120 South Riverside Plaza, Chicago, IL, 60606, US

(73) Assignee: Industrial Technology Research Institute, Hsinchu (TW)

(21) Appl. No.: 10/922,657

(22) Filed: Aug. 19, 2004

(30) Foreign Application Priority Data
Apr. 16, 2004 (TW) 9311063

(51) Int. Cl. G01J 3/28

(52) U.S. Cl. 356/328

(57) ABSTRACT

A fluorescence inspection spectrometer uses a stimulated light beam emitted by a light source, passes through the first collimator, the polarization beam splitter, and the objective lens, and then focuses on a test object to detect the excited fluorescence. Through the first optical filter module, the second collimator, and the reception of the photo detector, the fluorescence is converted into an output signal for fluorescence signal analysis. The feature is that the objective lens is installed on an actuator. More accurate data can be measured by fine-tuning the actuator so that the objective lens reaches its optimal focal position.

### BACKGROUND OF THE INVENTION

1. Field of Invention

The invention relates to an inspection apparatus used in the biomedical related area and, in particular, to a fluorescence inspection spectrometer whose objective lens position can be adjusted.

2. Related Art

In recent years, the biomedical technology has great breakthroughs as a result of the prosperity of the semiconductor industry. The rapid development in electronic devices has kept pushing biomedical researches forward.

Currently, the inspection techniques in biomedical studies form a hot topic in the field. A conventional inspection method is to put a biochip on an optical disk with a data layer. A beam of light with a specific wavelength focuses on the disk for a reading device to pick up the fluorescent signal excited by the biochip and the signals from the data layer. Finally, the fluorescent signals and the data layer signals are processed by a data processing unit to build two-dimensional (2D) fluorescent signals on the biochip.

In the U.S. Pat. No. 6,320,660, “Sieving Apparatus for a Biochip,” discloses an optical sieving apparatus for detecting a sample. The optical device of the biochip sieving apparatus and the normal fluorescent inspection spectrometer is usually comprised of a probe mechanism (i.e., a convergent component) and a receiving mechanism (i.e., a photo detector). Through the guidance of components such as objective lenses, the probe mechanism converges an optical signal emitted by a light source on a sample. The receiving mechanism uses a photo detector (PD) to receive the optical signals.

Both the biochip sieving apparatus and the normal fluorescent inspection spectrometer contain more optical devices (e.g., the microscopic objective lens, objective lens, or photoelectric multipliers) and have a larger size. Therefore, the precision of the ensemble is often reduced because the errors in positions of different optical devices. This affects the measurement results.

During operations, users often measure the fluorescent signals from several different locations in order to save the time for measuring samples and comparing data.

Unfortunately, when several light sources are used to measure fluorescent signals from different locations, errors; in the fluorescence reaction positions or optical device assembly result in certain fluorescent signals undetectable. Consequently, the user can only extract rough numbers and sometimes has to ignore those data with larger errors. These all cause experimental errors.

Therefore, how to simplify the testing mechanism in the fluorescent inspection spectrometer and to reduce the errors during the optical device assembly are important issues that need to be solved immediately.

### SUMMARY OF THE INVENTION

In view of the foregoing, the invention provides a fluorescent inspection spectrometer. A convergent objective lens is installed on an actuator so that an optimized focal distance can be reached for more precise experimental data by tuning the actuator. In this case, the user will not encounter the situation where no fluorescent signal radiated from the sample can be detected or only a rough value can be obtained.

A fluorescent inspection spectrometer of the invention contains: a light source, a first collimator, a polarization beam splitter, a first optical filter module, an objective lens, an actuator, a second collimator, and a photo detector.

The light source emits a stimulated light beam. The first collimator is provided on one side of the light source in order to receive the light beam and convert it into a parallel beam. The polarization beam splitter is installed on one side of the first collimator to receive the parallel beam and to reflect it out. The first optical filter module is provided by the light-emergent edge of the polarization beam splitter for filtering optical signals of different wavelengths.

The objective lens is installed on the actuator on one side of the polarization beam splitter. The objective lens can reach an optimized focal position by fine-tuning the actuator. The reflected parallel beam passes the objective lens and converges on the sample.

The sample under the parallel beam will excite inspection fluorescence with a specific wavelength. The fluorescence is converted by the objective lens into a parallel beam that goes through the polarization beam splitter.

To prevent the laser and other background light or noise light from entering the photo detector, the invention uses the polarization beam splitter and the first optical filter module by its light-emergent edge to filter the laser and other background light or noise light. Therefore, the invention provides more accurate measurement results.

The second collimator is installed on one side of the first optical filter module in order to converge the fluorescence with a specific wavelength. Finally, the photo detector installed by the side of the second collimator converts the received fluorescence into an output signal for further analysis.

### BRIEF DESCRIPTION OF THE DRAWINGS

The invention will become more fully understood from the detailed description given hereinbelow illustration only, and thus are not limitative of the present invention, and wherein:

FIG. 1 is a system diagram of the fluorescent inspection spectrometer in a first embodiment of the invention;

FIG. 2 is a system diagram of the fluorescent inspection spectrometer in a second embodiment of the invention; and

FIG. 3 is a system diagram of the fluorescent inspection spectrometer in a third embodiment of the invention.

### DETAILED DESCRIPTION OF THE INVENTION

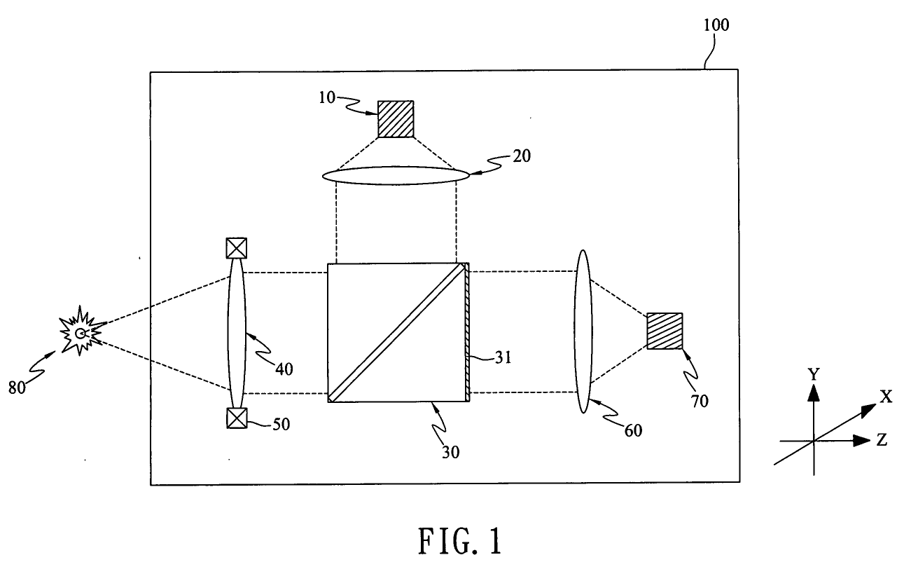

As shown in FIG. 1, a first embodiment of the disclosed fluorescence inspection spectrometer 100 for measuring a single sample contains: a light source 10, a first collimator 20, a polarization beam splitter 30, a first optical filter module 31, an objective lens 40, an actuator 50, a second collimator 60, and a photo detector 70.

The light source 10 emits a stimulated light beam. Common choices on the market include gas lasers and mercury lamps that have continuous spectra. These types of light sources are very expensive. The mercury lamp, in particular, has a shorter lifetime. Therefore, in this embodiment we use a single-wavelength laser diode with similar functions as the light source 10. In the following, we use a laser with the wavelength of 450 nm. Of course, the wavelength of the light beam varies with the dye added to the sample 80 in order to make the sample 80 exciting inspection fluorescence with a specific wavelength. Thus, the invention is not limited to stimulated light source 10 with the wavelength of 450 nm.

The first collimator 20 is installed on one side of the light source 10. It is used to receive the laser emitted from the light source 10 and to convert it into a parallel beam or a convergent beam.

The polarization beam splitter 30 is provided on one side of the first collimator 20 to receive the parallel beam output from the first collimator 20 and to reflect the parallel beam out along the 45-degree plane. The first optical filter module 31 is installed by the light-emergent edge of the polarization beam splitter 30 for filtering optical signals of different wavelengths. The first optical filter module 31 is formed by coating at the light-emergent edge of the polarization beam splitter 30. It can be a single-layer or multiple-layer filter. The number of filters is determined by the user according to different measurement needs.

The objective lens 40 is a non-spherical objective lens disposed on one side of the polarization beam splitter 30 and on the route of the light beam after the reflection. The objective lens 40 converge the parallel beam reflected by the polarization beam splitter 30 on the sample 80. The objective lens 40 is installed on an actuator 50 for fine-tuning the objective lens 40. (In this plot, fine-tuning of the actuator 50 adjusts the position of the objective lens 40 on the z-axis.) The actuator 50 can be a coil motor or any other device that can adjust the position of the objective lens 40.

Therefore, one can use the actuator 50 to fine-tune the position of the objective lens 40 for an optimized converging position in order to focus the entire light beam on the sample 80. The sample 80 excites inspection fluorescence with a specific wavelength by the light beam. The wavelength of the fluorescence is tens of nanometers (nm), greater than that of the stimulated light beam, whereas its intensity is only tens of nano-Watt (nW).

The fluorescence is converted by the objective lens 40 into a parallel beam, following the original optical path back to the polarization beam splitter 30. The polarization beam splitter 30 lets all of the collected fluorescence to pass through, reflecting most of the light beam. However, to prevent residual laser of wavelength 450 nm and other background or noise light from entering the photo detector 70 to affect the precision of measurements, the first optical filter module 31 removes the light beam and other background or noise light. To achieve a better filtering effect, a multiple-layer optical filter is coated at the light-emergent edge of the polarization beam splitter 30, removing unnecessary optical signals as much as possible.

Since the parallel beam has a wider range but a lower energy, the first optical filter module 31 is installed on one side of the second collimator 60 to increase the energy for easy detection.

Finally, the photo detector 70 provided on one side of the second collimator 60 converts the received fluorescence into an output signal for fluorescence signal analysis. The photo detector 70 processes the signal and sends it back to the actuator 50. The photo detector 70 can be a photo diode (PD) or an avalanche photo detector (APD).

The means of controlling the motion of the actuator is first entering a reference signal to the actuator 50 before the operation of the fluorescence inspection spectrometer 100. The reference signal is for the reference of tuning the actuator 50 to the best convergent position.

When the actuator 50 receives the output signal returned by the photo detector 70, it compares the reference signal and the output signal to determine the direction and displacement of the actuator in order to reach the best convergent position.

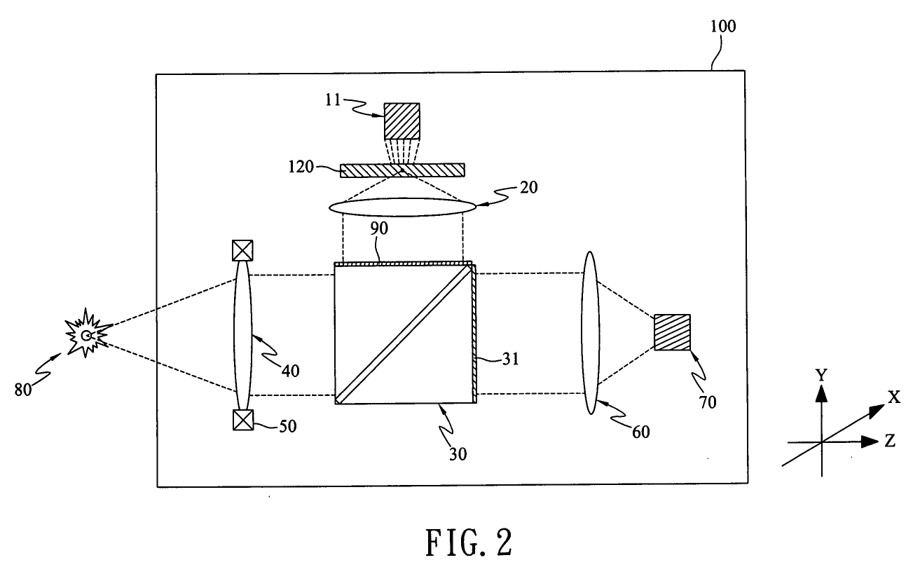

As shown in FIG. 2, the second embodiment is similar to the first embodiment. However, the light source 10 uses a light-emitting diode (LED) 11 to emit the stimulated light beam. A set of spacial filter 120 is inserted between the LED 11 and the first collimator 20 as a point light source. The light-incident edge of the polarization beam splitter 30 is coated with a second optical filter module 90 to select an appropriate frequency section of the light source.

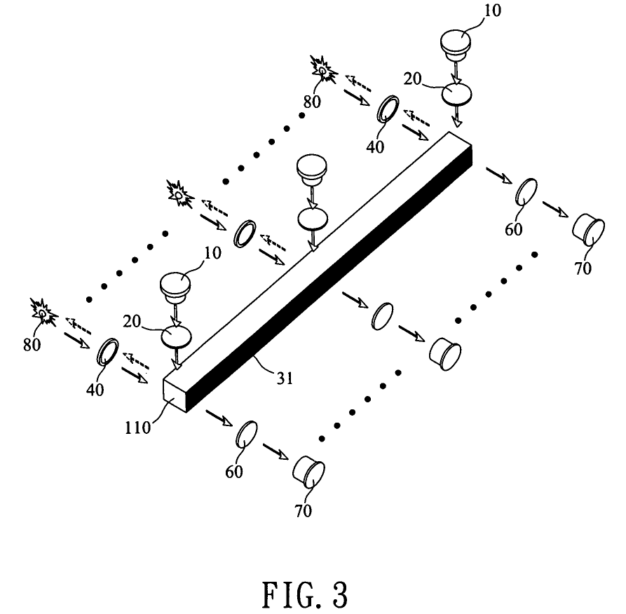

As shown in FIG. 3, the system structure of the third embodiment is similar to the first embodiment. However, the first embodiment can measure the fluorescence radiated by a single sample 80 only. The current embodiment is more suitable if the user wants to measure the fluorescence signals excite from several samples 80.

Basically, the third embodiment is constructed by disposing several sets of the first embodiments in parallel. The current embodiment uses several sets of the same test optical routes and optical devices to simultaneously measure the fluorescent signals excite from several samples 80. To reduce the number of optical devices in the embodiment, the original polarization beam splitters 30 in individual spectrometers 100 are formed into a long polarization beam splitter module 110 to be directly embedded into an optical carrier. The original first optical filter modules 31 are formed at the light-emergent edge of the polarization beam splitter module 110 by coating in a similar way.

The third embodiment can use either a laser diode or an LED as its light source 10. When it takes an LED as its light source 10, a second optical filter module 90 is used. The description of its structure is not repeated here.

Certain variations would be apparent to those skilled in the art, which variations are considered within the spirit and scope of the claimed invention.

1. A fluorescence inspection spectrometer for shining a sample and receiving an inspection fluorescence excited from the sample, the fluorescence inspection spectrometer comprising:
a light source, which emits a stimulated light beam;
a first collimator, which is installed on one side of the light source to receive the light beam and to convert the light beam into a parallel beam;
a polarization beam splitter, which is installed on one side of the first collimator to receive and reflect the parallel beam, a first optical filter module being provided at the light-emergent edge of the polarization beam splitter;
an objective lens, which is installed on one side of the polarization beam splitter on an actuator; wherein the actuator is fine-tuned so that the reflected parallel beam passes through the objective lens and converges to the sample, the sample excite the inspection fluorescence with a specific wavelength by the parallel beam, the fluorescence is converted by the objective lens into a parallel beam going through the polarization beam splitter, and the first optical filter module removes optical signals with other wavelengths;
a second collimator, which is installed on one side of the first optical filter module in order to converge the fluorescence with the specific wavelength; and
a photo detector, which is installed on one side of the second collimator to receive the converged fluorescence and to convert it into an output signal.

2. The fluorescence inspection spectrometer of claim 1, wherein a reference signal is sent to the actuator for the actuator to compare the reference signal with the output signal, thereby determining the direction and magnitude of moving the actuator.

3. The fluorescence inspection spectrometer of claim 1, wherein the light source is a laser diode.

4. The fluorescence inspection spectrometer of claim 1, wherein the light source is a light-emitting diode (LED).

5. The fluorescence inspection spectrometer of claim 4 further comprising a second optical filter module installed at the light-incident edge of the polarization beam splitter.

6. The fluorescence inspection spectrometer of claim 4 further comprising a spacial filter installed between the LED and the first collimator for converging and converting the optical beam into the parallel beam.

7. The fluorescence inspection spectrometer of claim 1, wherein the objective lens is a non-spherical objective lens.

8. The fluorescence inspection spectrometer of claim 1, wherein the actuator is a voice coil motor.

9. The fluorescence inspection spectrometer of claim 1, wherein the first optical filter module contains a plurality of optical filters.

10. The fluorescence inspection spectrometer of claim 1, wherein the photo detector is a photo diode (PD).

11. The fluorescence inspection spectrometer of claim 1, wherein the photo detector is an avalanche photo detector (APD).

12. A fluorescence inspection spectrometer for shining a plurality of samples disposed in a straight line and receiving a plurality of inspection fluorescences excite from the samples, the fluorescence inspection spectrometer comprising:
a plurality of light sources disposed in a straight line, each of which emits a stimulated light beam;
a plurality of first collimators disposed in a straight line, each of which is installed on one side of the corresponding light source to receive the light beam and to convert the light beam into a parallel beam;
a long polarization beam splitter module, which is installed on one side of the first collimators to receive and reflect the parallel beams, a first optical filter module being provided at the light-emergent edge of the polarization beam splitter module;
a plurality of objective lenses disposed in a straight line, each of which is installed on one side of the polarization beam splitter module and on an actuator; wherein the actuators are fine-tuned so that the reflected parallel beams pass through the objective lenses and converge to the corresponding samples, the samples excite the inspection fluorescence with a specific wavelength by the parallel beams, the fluorescence are converted by the objective lenses into parallel beams going through the polarization beam splitter module, and the first optical filter module removes optical signals with other wavelengths;
a plurality of second collimators, each of which is installed on one side of the first optical filter module in order to converge the fluorescence with the specific wavelength; and
a plurality of photo detectors, each of which is installed on one side of the corresponding second collimator to receive the corresponding converged fluorescence and to convert it into an output signal.

13. The fluorescence inspection spectrometer of claim 12, wherein a reference signal is sent to each of the actuators for the actuator to compare the reference signal with the output signal, thereby determining the direction and magnitude of moving the corresponding actuator.

14. The fluorescence inspection spectrometer of claim 12, wherein the light source is a laser diode.

15. The fluorescence inspection spectrometer of claim 12, wherein the light source is a light-emitting diode (LED).

16. The fluorescence inspection spectrometer of claim 15 further comprising a second optical filter module installed at the light-incident edge of the polarization beam splitter.

17. The fluorescence inspection spectrometer of claim 15 further comprising a spacial filter installed between each of the LED's and the corresponding first collimator for converging and converting the optical beam into the parallel beam.

18. The fluorescence inspection spectrometer of claim 12, wherein each of the objective lenses is. a non-spherical objective lens.

19. The fluorescence inspection spectrometer of claim 12, wherein each of the actuators is a voice coil motor.

20. The fluorescence inspection spectrometer of claim 12, wherein the first optical filter module contains a plurality of optical filters.

21. The fluorescence inspection spectrometer of claim 12, wherein each of the photo detectors is a photo diode (PD).

22. The fluorescence inspection spectrometer of claim 12, wherein each of the photo detectors is an avalanche photo detector (APD).
